(19) United States
(12) Patent Application Publication
(10) Pub. No.: US 2011/0072615 A1
(43) Pub. Date: Mar. 31, 2011

(54) HINGE DEVICE

(76) Inventor: Masashi Tanemura, Tokyo (JP)

(21) Appl. No.: 12/995,266

(22) PCT Filed: May 26, 2009
(86) PCT No.: PCT/JP2009/059936

§ 371 Date: Nov. 30, 2010

(30) Foreign Application Priority Data
May 30, 2008 (JP) 2008-143709

(51) Int. Cl. E05F 1/08

(52) U.S. Cl. 16/277

(57) ABSTRACT

A hinge device used for a foldable opening/closing device includes: a first member 2 attached to one side of the foldable device; a second member 3 attached to the other side of the foldable device; a shaft member 4 for joining the first and second members in a manner to enable them to make rotational movement; elastic means 5, attached to the shaft member, for applying a compression force to the first and second members; and a plurality of spacer members 6 that are attached to the shaft member and are compressed by the elastic means, wherein the plurality of spacer members include a first spacer member 61 moving rotationally together with the first member and a second spacer member 62 adjacent to the first spacer member and moving rotationally together with the second member, and in one or both of the first and second spacer members, a through hole 7 that penetrates a spacer surface is formed, and the through hole 7 is filled with grease.

### TECHNICAL FIELD

The present invention relates to a hinge device used in a foldable opening/closing device such as a personal computer.

### BACKGROUND ART

The opening angle of a display part in a foldable opening/closing device such as a personal computer varies depending on a user, and there is thus used a hinge device including a so-called free stop mechanism capable of holding the display part at any position by any opening angle.

As this type of hinge device, there is known a device which is called a side pressure hinge. This hinge device includes: a first member and a second member attached to one side and the other side of the foldable device (PC, etc.); a shaft member for joining the first and second members in a manner to enable them to make rotational movement; elastic means, attached to the shaft member, for applying a compression force to the first and second members; and a plurality of spacer members, attached to the shaft member, compressed by the elastic means, wherein the spacer members are configured by a first spacer member moving rotationally together with the first member and a second spacer member, adjacent to the first spacer member, moving rotationally together with the second member, and the spacer members respectively pressure-slide to realize free stopping (for example, see Patent Document 1, FIG. 1, FIG. 2, etc.).

### [Citation List]

### [Patent Document]

[Patent Document 1]
Japanese Patent Application Laid-Open Publication No. 2001-32823

### DISCLOSURE OF INVENTION

### [Problems to be Solved by the Invention]

The foldable opening/closing device is highly frequently opened and closed, and is set, for example to withstand 20,000 to 30,000 times of open/close operations as manufacturing specifications. Besides, it is demanded that a sliding part of a personal computer, etc., as the foldable opening/closing device, exhibits high wear resistance because the side pressure torque (hereinafter, simply called a torque) is large in order to realize the free stopping.

On one hand, as the foldable device (PC, etc.) becomes more lightweight, the rotation part of the hinge tends to be smaller in diameter. On the other hand, high durability is required. Above all, if the sliding part is significantly worn from many years of uses, the initial torque drops and the torque down rate becomes gradually higher. It is needed to keep the torque down rate below a predetermined value in order to withstand a certain duration of usage.

Moreover, the compact hinge leads to a smaller diameter of the sliding part; at the same time, a high torque is applied to the sliding part. The inventors of the present application regarded problems involving a smaller in diameter of the sliding part as a result of the compact hinge and the wear resistance of the sliding part as a result of the high torque being applied, as serious problems, if the above-described requirements of a small diameter/high torque is to be met. This prompted the inventors to come to realize and achieve the present invention through studies of a relation between wear and a torque down rate based on an experimental data while keeping in mind that the reduction of high torque by disposing a plurality of spacer members in the sliding part, as the basis of this idea.

### [Means for Solving the Problems]

A hinge device of the present invention will be described with reference numerals used in the following embodiment that the hinge device used for a foldable opening/closing device comprising:
a first member 2 attached to one side of the foldable device;
a second member 3 attached to the other side of the foldable device; a shaft member 4 for joining the first and second members in a manner to enable them to make rotational movement; elastic means 5, attached to the shaft member 4, for applying a compression force to the first and second members 2 and 3; and a plurality of spacer members 6 that are attached to the shaft member 4 and are compressed by the elastic means 5, wherein
the plurality of spacer members 6 include a first spacer member 61 moving rotationally together with the first member 2 and a second spacer member 62 adjacent to the first spacer member 61 and moving rotationally together with the second member 3, and
in one or both of the first and second spacer members 61 and 62, a through hole 7 that pierces through a spacer surface is formed, and the through hole 7 is filled with grease.

Further, the hinge device of the present invention is a hinge device, wherein the first member 2 comprises: a rising piece 21 through which the shaft member 4 penetrates; and a protrusion 22 for preventing rotation of either one of the first spacer member 61 or the second spacer member 62, the through hole 7 that pierces through a shaft-member penetrating direction is formed in the rising piece 21, and the through hole 7 is filled with grease.

Moreover, the hinge device of the present invention is a hinge device, wherein a grease holding member for supplementing the filled grease is inserted into the through hole 7.

### [Effects of the Invention]

As described above, the present invention relates to a hinge device used in a foldable opening/closing device, comprising: a first member 2 attached to one side of the foldable device; a second member 3 attached to the other side of the foldable device; a shaft member 4 for joining the first and second members in a manner to enable them to make rotational movement; elastic means 5, attached to the shaft member 4, for applying a compression force to the first and second members 2 and 3; and a plurality of spacer members 6 that are attached to the shaft member 4 and are compressed by the elastic means 5, wherein the plurality of spacer members 6 include a first spacer member 61 moving rotationally together with the first member 2 and a second spacer member 62 adjacent to the first spacer member 61 and moving rotationally together with the second member 3. When comparison is made between a case where in applying grease, a concentric grease reservoir groove is used on a slide-contact surface of one of or both of the first and second spacer members 61 and 62 and a case where a through-hole 7 that pierces through a spacer surface is formed in one or both of the first and second spacer members 61 and 62 and the through hole 7 is filled with grease, the latter, that is, the present invention could have obtained a hinge device with a lesser torque down rate, as shown in an experimental data which will be described later.

Moreover, a durability test was performed by using a sliding part made of carbon tool steel SK5 (hardened) on which non electrolytic nickel plating was applied according to the same specifications as those in the experiment which will be described later. The result was that black powder was so frequently generated that the durability test had to be canceled. In this experiment, an SUS material was used as the material of the sliding part.

### BRIEF DESCRIPTION OF DRAWINGS

FIG. 1 is a perspective view of a hinge device according to one embodiment of the present invention.

FIG. 2 is an exploded perspective view of the hinge device shown in FIG. 1.

FIG. 3(a) to FIG. 3(f) are diagrams showing the hinge device shown in FIG. 1, wherein FIG. 3(a) is a front view, FIG. 3(b) is a plan view, FIG. 3(c) is a bottom view, FIG. 3(d) is a right-side view, FIG. 3(e) is a left-side view, and FIG. 3(f) is a rear view.

FIG. 4 is an experimental data obtained by using the hinge device of the present embodiment, and which is a “grease reservoir small, R0.1” type.

FIG. 5 is an experimental data obtained by using the hinge device of the present embodiment, and which is a “grease reservoir small, R0.1” type.

FIG. 6 is an experimental data obtained by using the hinge device of the present embodiment, and which is a “grease reservoir small, R0.1” type.

FIG. 7 is an experimental data obtained by using the hinge device of the present embodiment, and which is a “grease reservoir small, R0.1” type.

FIG. 8 is an experimental data obtained by using the hinge device of the present embodiment, and which is a “grease reservoir small, R0.1” type.

FIG. 9 is an experimental data obtained by using the hinge device of the present embodiment, and which is a “grease reservoir small, R0.1” type.

FIG. 10 is an experimental data obtained by using the hinge device of the present embodiment, and which is a “grease reservoir large, R0.2” type.

FIG. 11 is an experimental data obtained by using the hinge device of the present embodiment, and which is a “grease reservoir large, R0.2” type.

FIG. 12 is an experimental data obtained by using the hinge device of the present embodiment, and which is a “grease reservoir large, R0.2” type.

FIG. 13 is an experimental data obtained by using the hinge device of the present embodiment, and which is a “grease reservoir large, R0.2” type.

FIG. 14 is an experimental data obtained by using the hinge device of the present embodiment, and which is a “grease reservoir large, R0.2” type.

FIG. 15 is an experimental data obtained by using the hinge device of the present embodiment, and which is a “grease reservoir large, R0.2” type.

### THE BEST MODE OF CARRYING OUT THE INVENTION

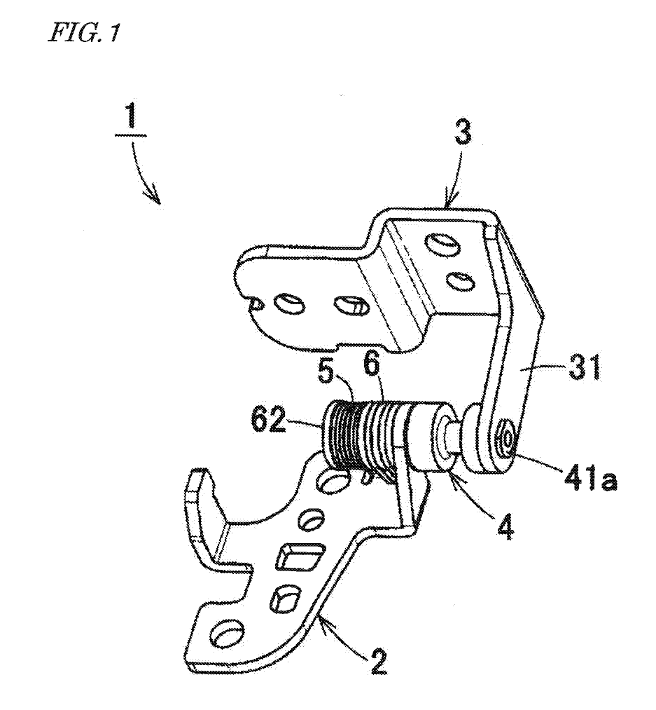

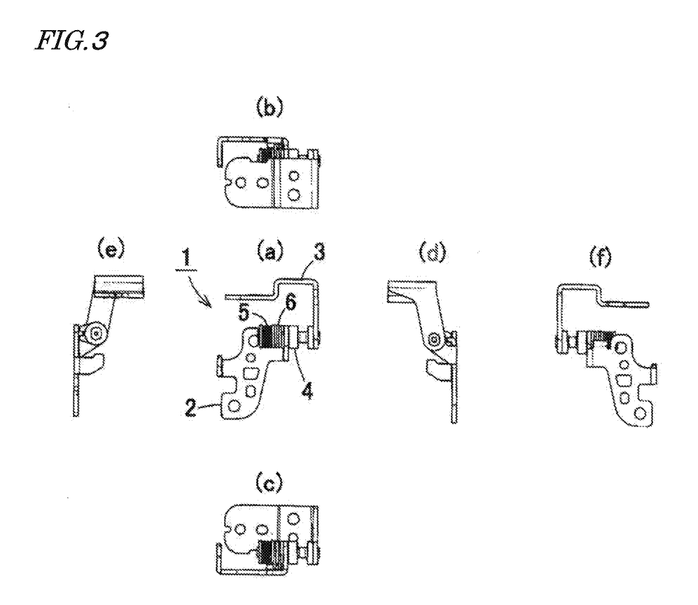

The hinge device of the present invention is a hinge device used in a foldable opening/closing device as shown in FIG. 1 to FIG. 3, and comprises: a first member 2 attached to one side of the foldable device; a second member 3 attached to the other side of the foldable device, a shaft member 4 for joining the first and second members 2 and 3 in a manner to enable them to make rotational movement; elastic means 5, attached to the shaft member 4, for applying a compression force to the first and second members 2 and 3; and a plurality of spacer members 6 that are attached to the shaft member 4 and are compressed by the elastic means 5.

The plurality of spacer members 6 include a first spacer member 61 moving rotationally together with the first member 2 and a second spacer member 62 adjacent to the first spacer member 61 and moving rotationally together with the second member 3. In one or both of the first and second spacer members 61 and 62, a through-hole 7 that pierces through a spacer surface is formed.

In the present invention, when the through-hole 7 is filled with grease, it becomes possible to obtain a hinge device with a lesser torque down rate, as will be described later.

The first member 2 includes: a rising piece 21 through which the shaft member 4 penetrates; and a protrusion 22 for preventing the rotation of either one of the first spacer member 61 or the second spacer member 62. In the rising piece 21, the through-hole 7 that pierces through a shaft-member penetrating direction is formed. This through hole 7 is also filled with grease.

Moreover, a grease holding member for supplementing the filled grease may be inserted into the through-hole 7. This leads to a good grease holding condition.

In this embodiment, the first spacer member 61 is engaged with the protrusion 22 of the first member 2 so as to make rotational movement together with the first member 2.

It is noted that a through hole 23 of the rising piece 21 through which the shaft member 4 penetrates corresponds to a columnar region of a region of a shaft part 41 which is inserted through the through hole 23, and is circularly shaped. The inserted shaft part 41 is arranged rotatably with respect to the through hole 23.

The second member 3 includes a folded piece 31 in the same surface direction as that of the rising piece 21 of the first member 2. In this folded piece 31, an attaching hole 32 for fixing one end 41a of the shaft part 41 of the shaft member 4 is arranged.

In this embodiment, the one end 41a of the shaft part 41 is inserted into the attaching hole 32, and after that, the end 41a is fixed in the attaching hole 32 by caulking.

The shaft member 4 includes: the shaft part 41 of which the end 41a is fixed in the attaching hole 32, a first flange 42 and a second flange 43 arranged in the shaft part 41. In a columnar part 44 on the other end of the shaft part 41, a chamfered part 45 is formed.

Moreover, elastic means 5 is attached to the columnar part 44. In this embodiment, the elastic means 5 is configured by a plurality of disc springs 51, 51. Second spacer member 62, which will be described in detail later, is disposed at the both ends of the disc springs 51, 51.

In this embodiment, the other end 41b of the shaft part 41 is inserted into a through hole 62a of the second spacer member 62 which is farthest from the rising piece 21 of the first member 2, and after that, the end 41b is fixed in the second spacer member 62 by caulking.

The first spacer member 61 of the spacer member 6 moves rotationally together with the first member 2, as described above. In this embodiment, one part of the first spacer member 61 is extended, and in the extended region, a notch 61a latched to the protrusion 22 of the first member 2 is provided. The notch 61a is latched to the protrusion 22, and thus, the first spacer member 61 moves rotationally along with the rotational movement of the first member 2.

In the second spacer member 62, there is provided a through hole 62a through which the shaft part 41 of the shaft member 4 is inserted. In the through hole 62a, a chamfered part 62b which fits in the chamfered part 45 provided in the columnar part 44 of the shaft part 41 is arranged. Therefore, when the shaft member 4 rotates, the chamfered part 45 arranged in the columnar part 44 of the shaft part 41 is engaged with the chamfered part 62b of the second spacer member 62, and as a result, the second spacer member 62 rotationally moves along with the rotational movement of the second member 3.

Reference numeral 8 denotes a washer, and the first member 2 is attached between the rising piece 21 of the shaft member 4 and the second flange 43 of the shaft member 4.

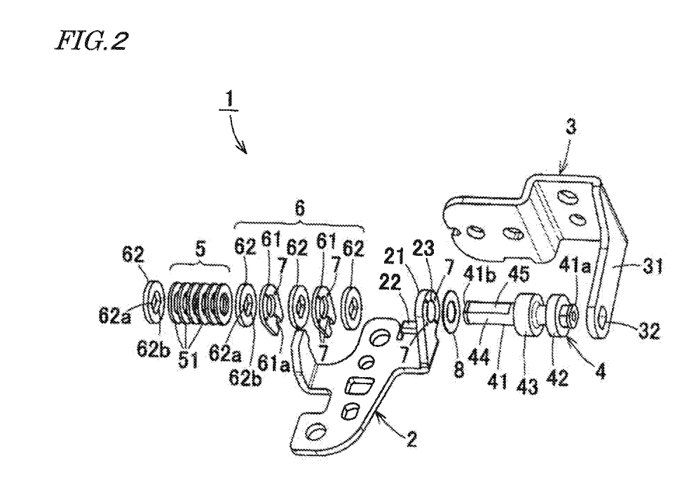

In a hinge device 1 of this embodiment shown in FIG. 1, after one end 41a of the shaft part 41 of the shaft member 4 is fixed in the attaching hole 32 of the second member 3, the shaft part 41 on the columnar part 44 side is inserted in the order through the washer 8, the through hole 23 of the rising piece 21 of the first member 2, the first spacer member 61 and the second spacer member 62 which are alternately disposed, a plurality of disc springs 51, 51 that are elastic means 5, and the second spacer member 62 situated at the end, after which the other end 41b of shaft part 41 is fixed in the second spacer member 62 situated at the end by caulking (See FIG. 2).

In the hinge device 1 which is assembled in this way, the first spacer member 61 and the second spacer member 62, the rising piece 21 of the first member 2, the washer 8, and the second flange 43 of the shaft member 4 are compressed by the elastic means 5, and as a result, frictional force is generated in these rotatably sliding parts, whereby a free stop mechanism is imparted to the foldable opening/closing device used for this device.

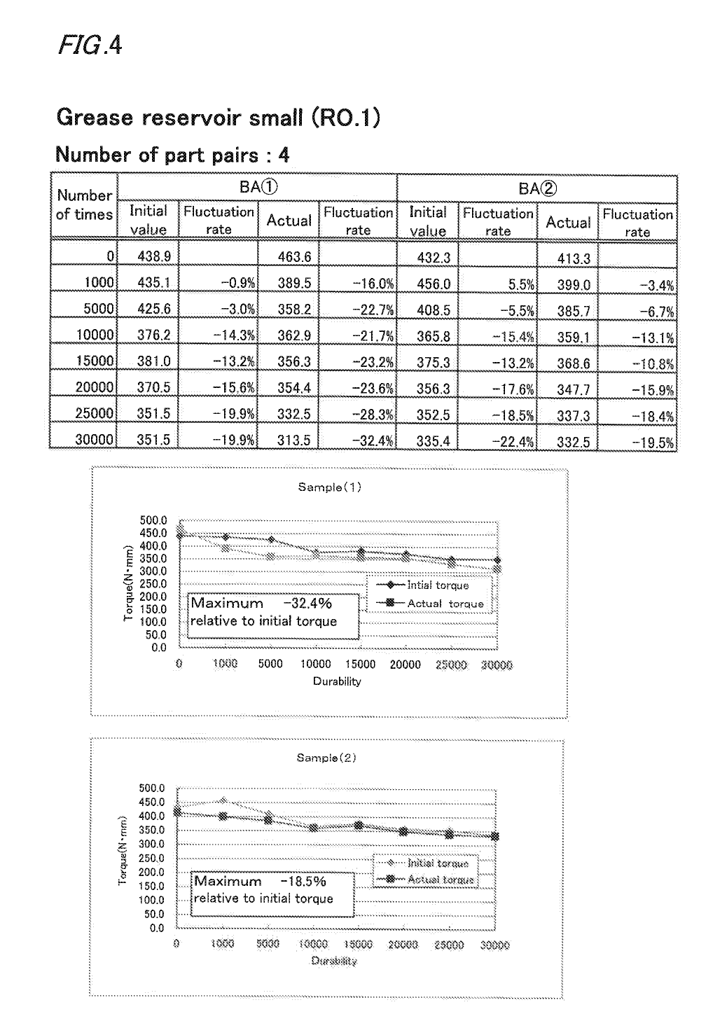

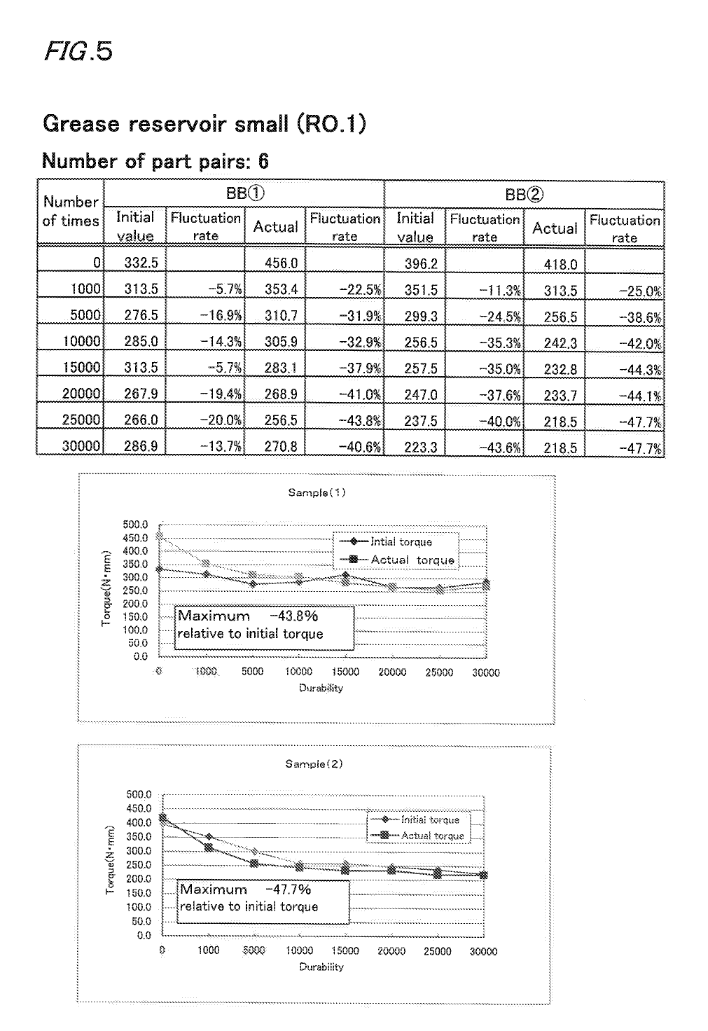

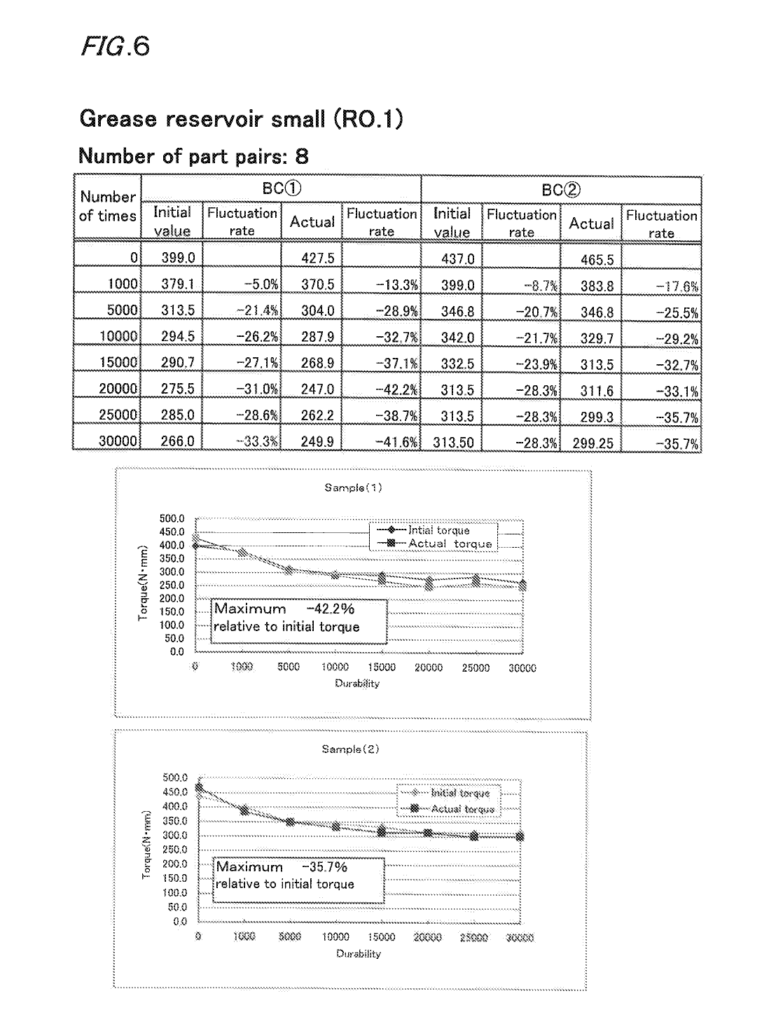

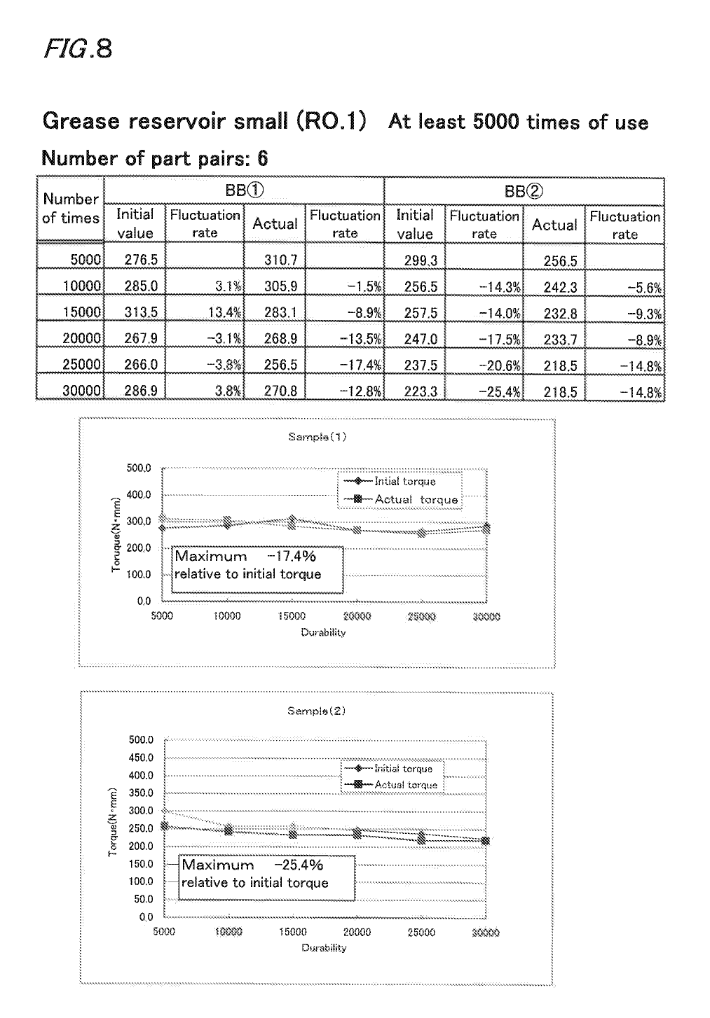

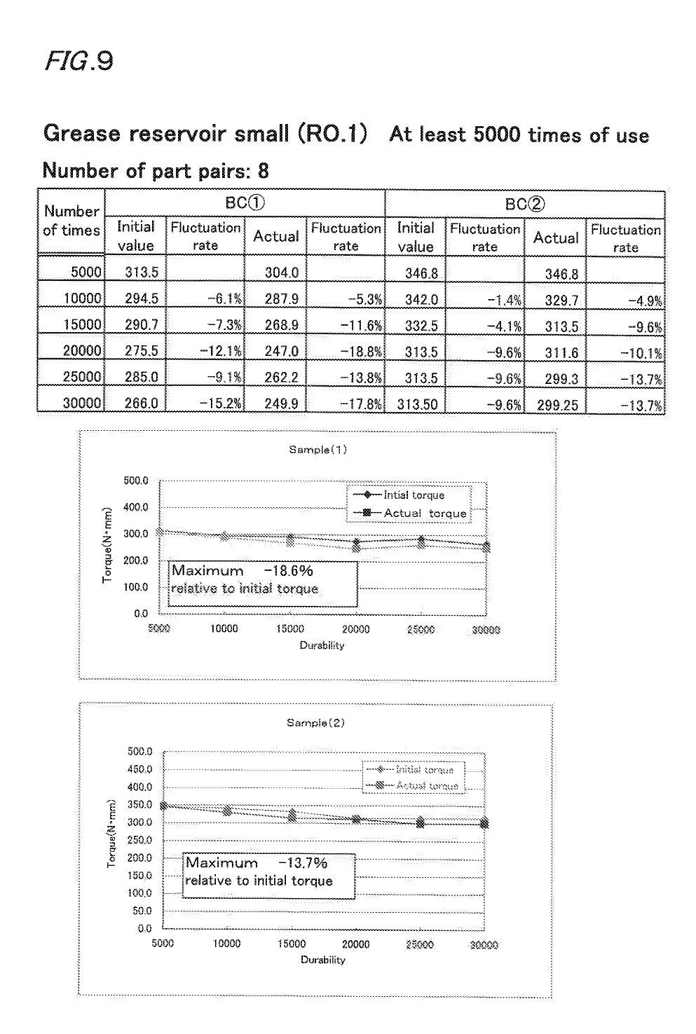

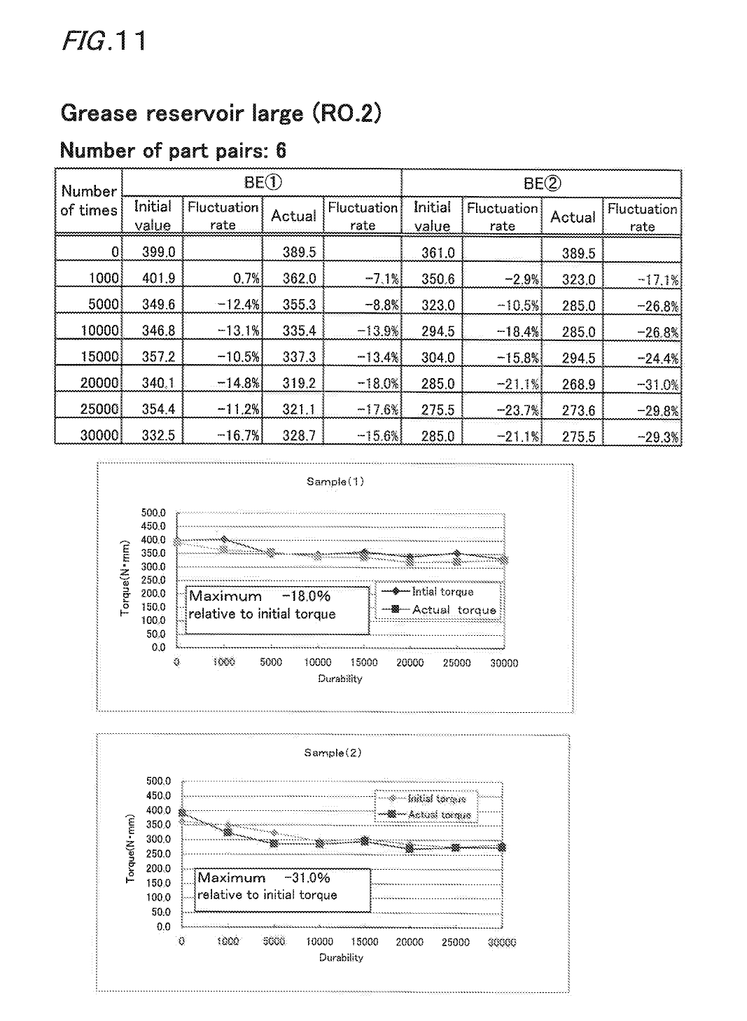

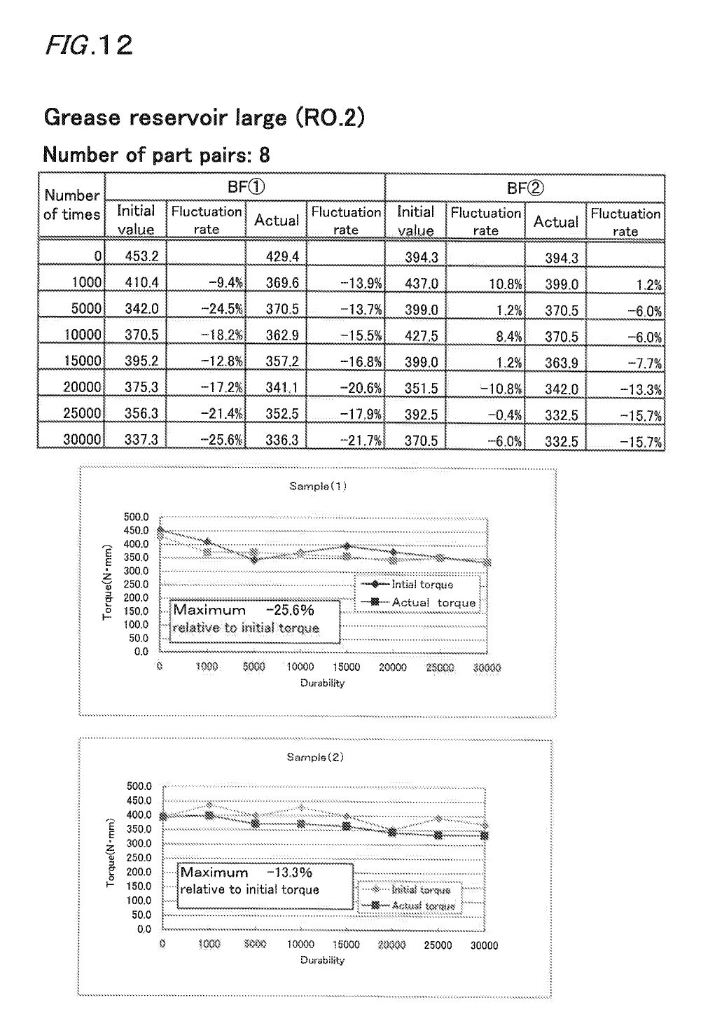

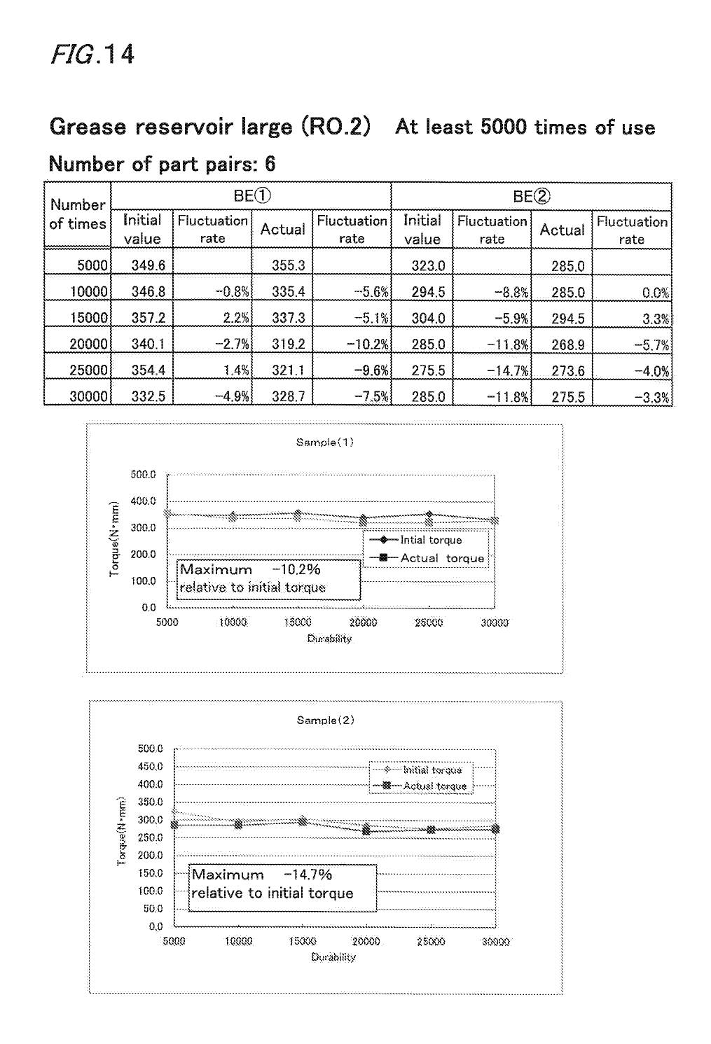

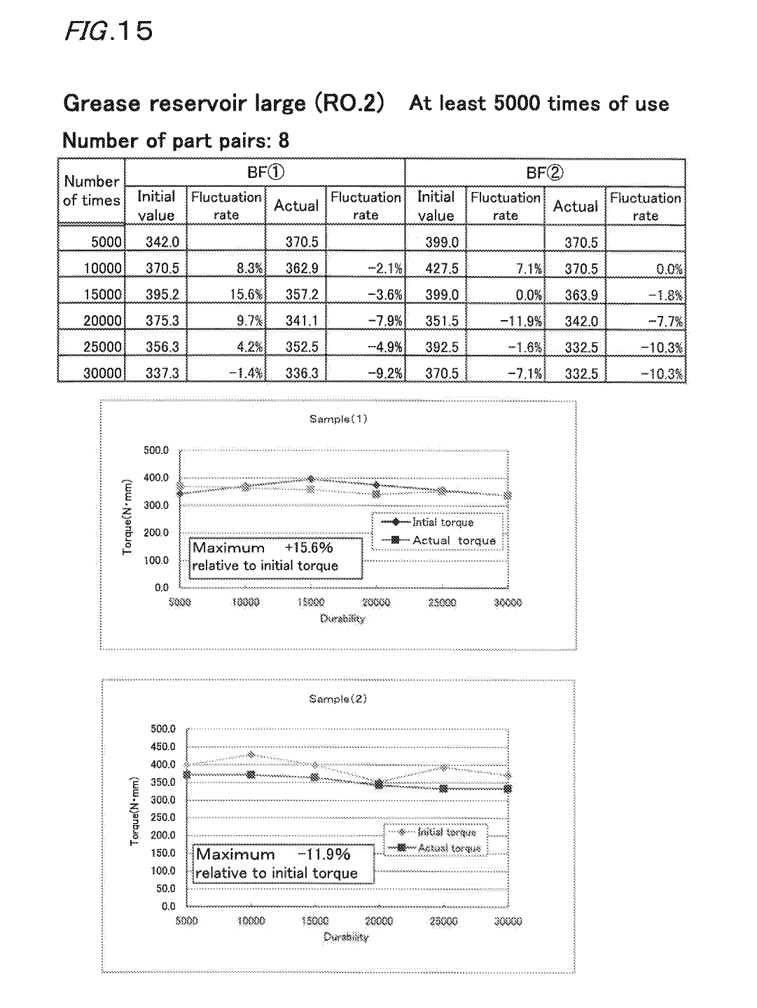

FIG. 4 to FIG. 15 show two types of hinge devices: one is configured such that on the slide-contact surface of the spacer member, a concentric grease reservoir groove is provided and its depth is “0.1 mm” (described as “grease reservoir small, R0.1”); and the other is configured such that on the slide-contact surface of the spacer member, four grease reservoir holes are provided in the shaft direction, as shown in FIG. 1, and the diameters of the holes are “0.2 mm” each (described as “grease reservoir large, R0.2”). Then, data such as the number of slide-contact surfaces (described as “the number of pairs of sliding parts”) which are “4”, “6”, and “8”; the durability of 0 to 30000 times of use, and durability of 5000 to 30000 times of use are taken and their torque fluctuation rates are recorded, thereby to obtain the above-described “torque down rate”.

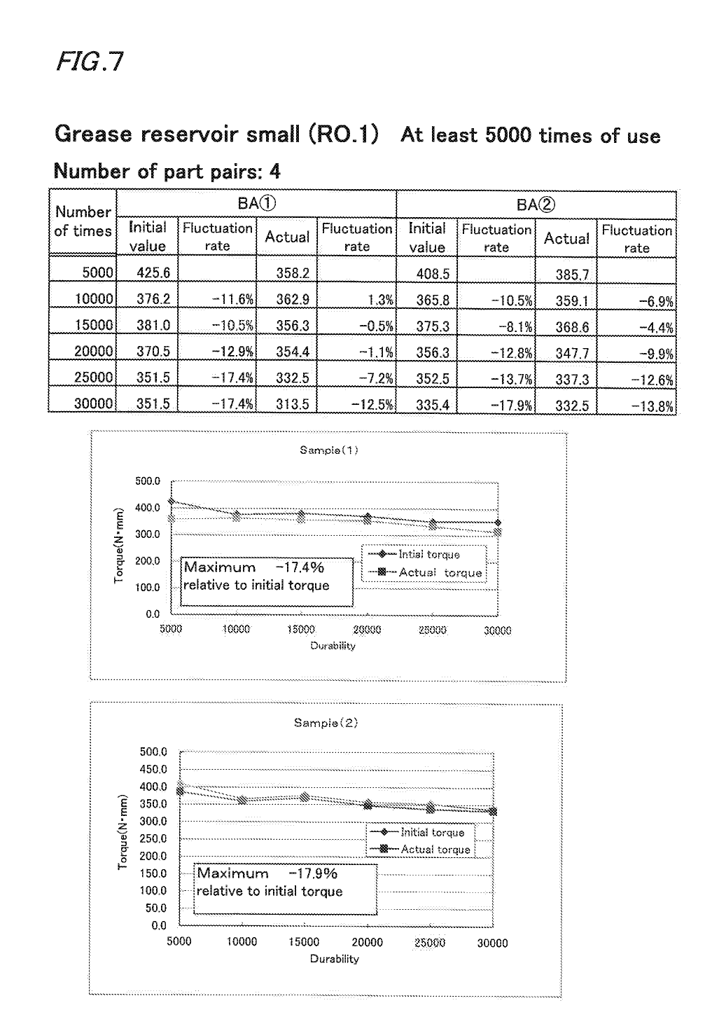

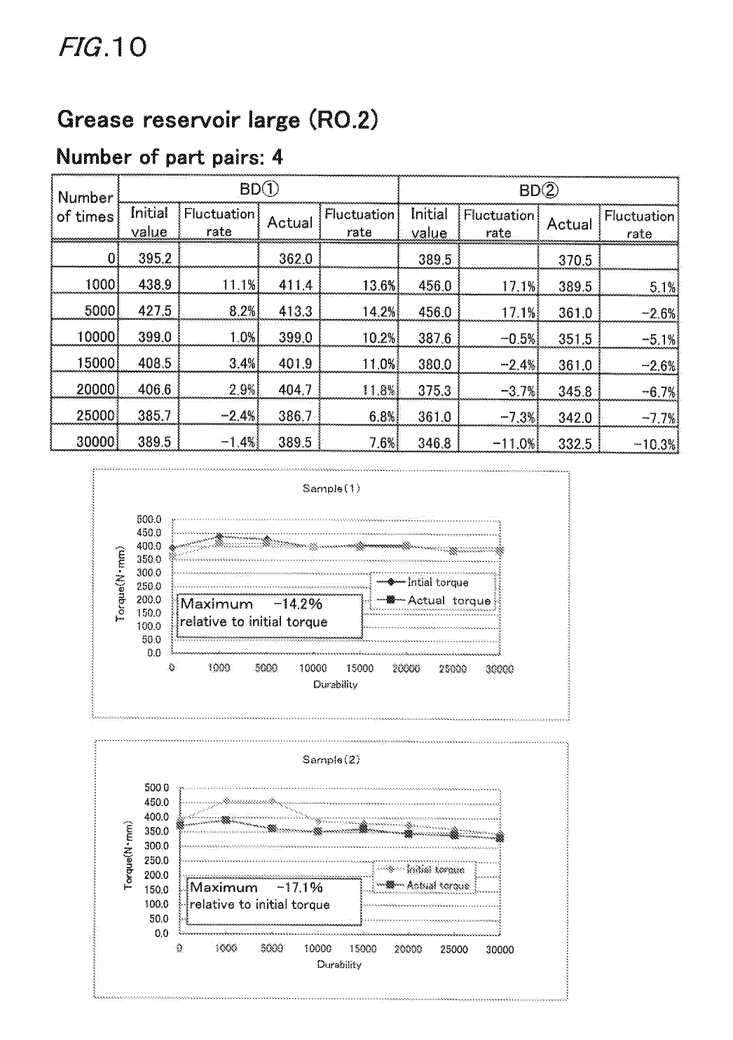

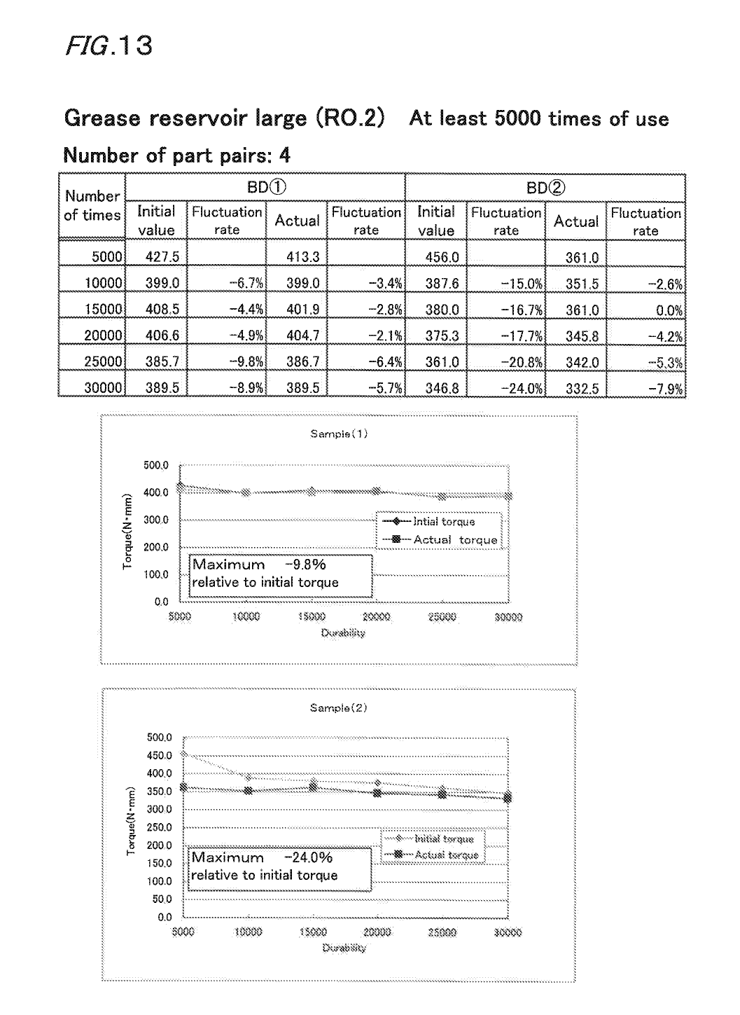

FIG. 4 to FIG. 15 respecting show various results: FIG. 4 to FIG. 6 show the results of “grease reservoir small, R0.1” and the number of pairs of “4”, “6” and “8”; and FIG. 7 to FIG. 9 show the results of “grease reservoir small, R0.1”, the number of pairs of “4”, “6” and “8”, and the durability of at least 5000 times of use. Similarly, FIG. 10 to FIG. 12 show the results of “grease reservoir large, R0.2” and the number of pairs of “4”, “6”, and “8”; and FIG. 13 to FIG. 15 show the results of “grease reservoir large, R0.2”, the number of pairs of “4”, “6”, and “8”, and the durability of at least 5000 times of use. It is noted that the durability of at least 5000 times of uses was required to conduct the experiments because it needed about 5000 times of use to smoothen the sliding parts, and the durability of at least 5000 times of use was selected.

Based on the above-described experimental data, it can be basically seen that from the standpoint of a difference in the grease reservoir shape, the type of “grease reservoir large, R0.2” has an overall tendency of a lesser torque down rate as compared to the type of “grease reservoir small, R0.1”. In particular, if a comparison is made between the type of “grease reservoir small, R0.1” in FIG. 4 to FIG. 6 and the type of “grease reservoir large, R0.2” in FIG. 10 to FIG. 12, then it is proved that there is a significant difference in the range of durability of 0 to 5000 times of uses.

This is probably because in the type of “grease reservoir large, R0.2”, the grease reservoir is large, the grease is thus left in the sliding part even during the durability operation, and therefore, the lubricity is maintained, and on the contrary, in the type of “grease reservoir small, R0.1”, the lubricity is relatively low, and thus, it is considered that the wear of the sliding part appears as a torque down phenomenon.

Then, regarding the difference in the number of pairs and surface pressure of the sliding parts is discussed, the type with the number of pairs “4”, out of those with the number of pairs of “4”, “6”, and “8”, have a torque up in the initial endurance (see FIG. 4 to FIG. 6 and FIG. 10 to FIG. 12). This is probably because if the number of pairs of the sliding parts is small, the surface pressure in those parts is high, and thus, the torque rises as jamming starts to appear after which the wear is progressed, shifting to the toque down.

Further, it was found that if a comparison is made in the case of the durability of at least 5000 times of use between the type of “grease reservoir small, R0.1” in FIG. 7 to FIG. 9 and the type of “grease reservoir large, R0.2” in FIG. 13 to FIG. 15, no abrupt change was discovered in the both types. This probably indicates that there was no problem in durability after the sliding surface was smoothened.

The experiments described above was conducted on a side pressure hinge with a 6 mm torque generator, and the experiment results proved that it could support up to 500 Nmm.

### INDUSTRIAL APPLICABILITY

The hinge device of the present invention is directed to be applied to a personal computer, etc.; however, in addition thereto, the hinge device can be applied to any product, such as a cosmetic compact, a door, or a toilet lid, which is opened/closed or moved rotationally and requires a free stop to its open/close or rotational movement.

### DESCRIPTION OF REFERENCE NUMERALS

1 hinge device
2 first member
21 rising piece
22 protrusion
23 insertion hole
3 second member
31 folded piece
32 attaching hole
4 shaft member
41 shaft part
41a end
41b end
42 first flange
43 second flange
44 columnar part
45 chamfered part
5 elastic means
51 disc spring
6 spacer member
61 first spacer member
61a notch
62 second spacer member
62a insertion hole
62b chamfered part
7 through hole
8 washer

1. A hinge device used for a foldable opening/closing device, comprising:
a first member attached to one side of the foldable device;
a second member attached to the other side of the foldable device;
a shaft member for joining the first and second members to be rotatable;
an elastic member attached to the shaft member for applying a compression force to the first and second members; and
a spacer members attached to the shaft member and compressed by the elastic means,
wherein the spacer member includes a first spacer member moving rotationally together with the first member and a second spacer member adjacent to the first spacer member and moving rotationally together with the second member, and at least one of the first and second spacer members has a through hole through a spacer surface thereof, said through hole being filled with grease.

2. The hinge device according to claim 1, wherein said first member includes a rising piece for passing the shaft member therethrough and a protrusion for preventing one of the first spacer member and the second spacer member from rotating, said through hole extending in a shaft-member penetrating direction and being formed in the rising piece, said through hole being filled with the grease.

3. The hinge device according to claim 1, further comprising a grease holding member inserted into the through hole for supplementing the grease.
